(19) United States
(12) Patent Application Publication
(10) Pub. No.: US 2024/0306058 A1
(43) Pub. Date: Sep. 12, 2024

(54) REDUCING UPLINK INTERRUPTION IN DUAL ACTIVE PROTOCOL STACK (DAPS) HANDOVER

(71) Applicant: Nokia Technologies Oy, Espoo (FI)

(72) Inventors: Ahmad AWADA, Munich (DE); Panagiotis SPAPIS, Munich (DE); Halit Murat GÜRSU, Munich (DE); Srinivasan SELVAGANAPATHY, Bangalore (IN); Jedrzej STANCZAK, Wroclaw (PL); Daniela LASELVA, Aalborg (DK)

(21) Appl. No.: 18/574,193

(22) PCT Filed: Jun. 20, 2022
(86) PCT No.: PCT/EP2022/066690

§ 371 Date: Dec. 26, 2023

(30) Foreign Application Priority Data
Jun. 28, 2021 (IN) 202141028920

(51) Int. Cl. H04W 36/02; H04W 40/12

(52) U.S. Cl. CPC H04W 36/02; H04W 40/125

(57) ABSTRACT

Systems, methods, apparatuses, and computer program products for reducing uplink interruption in dual active protocol stack (DAPS) handover. For example, the user equipment may transmit an indication either to a source cell or to a target cell that there is no more pending uplink medium access control and radio link control (re)-transmissions to be transmitted to the source cell, after the uplink switch to the target cell occurs during a DAPS handover. Based on the received indication, the network (e.g., the source cell or target cell) may perform one or more actions to enable forwarding of the uplink packets received from the user equipment by the target cell to a user plane function and/or serving gateway.

### CROSS-REFERENCE TO RELATED APPLICATION

This application is related to and claims the benefit and priority of IN Patent Application No. 202141028920, which was filed on Jun. 28, 2021, the entirety of which is hereby incorporated herein by reference.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to systems and/or methods for reducing uplink interruption in dual active protocol stack (DAPS) handover.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. 5G is mostly built on a new radio (NR), but a 5G (or NG) network can also build on E-UTRA radio. It is estimated that NR may provide bitrates on the order of 10-20 Gbit/s or higher, and may support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) may be named gNB when built on NR radio and may be named NG-eNB when built on E-UTRA radio.

### SUMMARY

According to a first embodiment, a method may include transmitting, to a source network node, one or more of: an indication that there are no pending uplink medium access control and radio link control transmissions to the source network node after an uplink switch to a target network node during a handover, or an indication that the uplink switch to the target node has occurred.

In a variant, the method may include receiving, from the source network node prior to transmitting the indication that there are no pending transmissions or an indication that the uplink switch to the target node has occurred, an indication to enable uplink interruption reduction during the handover. In a variant, the receiving the indication to enable the uplink interruption reduction may include receiving the indication to enable the uplink interruption reduction in a radio resource control configuration message. In a variant, the handover may include a dual active protocol stack handover.

According to a second embodiment, a method may include receiving, from a user equipment, one or more of: an indication that there are no pending uplink medium access control and radio link control transmissions to the apparatus after an uplink switch to a target network node during a handover, or an indication that that the uplink switch to the target network node has occurred. The method may include transmitting, to the target network node, an indication of a next uplink packet to be forwarded to another network node.

In a variant, the method may include transmitting, to the user equipment prior to receiving the indication that there are no pending transmissions or the indication that the uplink switch to the target network node has occurred, an indication to enable uplink interruption reduction during the handover. In a variant, the transmitting the indication to enable the uplink interruption reduction may include transmitting the indication to enable the uplink interruption reduction in a radio resource control configuration message. In a variant, the handover may include a dual active protocol stack handover. In a variant, the transmitting the indication of the next uplink packet may include transmitting the indication of the next uplink packet in a sequence number status transfer uplink message. In a variant, the other network node may include at least one of a serving gateway or a user plane node. In a variant, the method may include determining whether the user equipment has the pending uplink medium access control and radio link control transmissions based on receiving the indication that the uplink switch to the target network node has occurred.

According to a third embodiment, a method may include transmitting, to a target network node, an indication that there are no pending uplink medium access control and radio link control transmissions to a source network node after an uplink switch to the target network node during a handover and/or an indication of a next uplink packet to be transmitted to another network node.

In a variant, the method may include receiving, from the source network node, an indication to enable uplink interruption reduction during the handover. In a variant, the receiving the indication to enable the uplink interruption reduction may include receiving the indication to enable the uplink interruption reduction in a radio resource control configuration message. In a variant, the transmitting the indication may include transmitting the indication in a radio resource control reconfiguration complete message. In a variant, the transmitting the indication may include transmitting the indication after switching an uplink user plane.

According to a fourth embodiment, a method may include receiving, from a user equipment, an indication that there are no pending uplink medium access control and radio link control transmissions to a source network node after an uplink switch to the apparatus during a handover and/or an indication of a next uplink packet to be transmitted to another network node. The method may include transmitting, to the other network node, the next uplink packet.

In a variant, the method may include transmitting, to the source network node, an indication to enable uplink interruption reduction during the handover. In a variant, the transmitting the indication to enable the uplink interruption reduction may include transmitting the indication to enable the uplink interruption reduction in a handover request acknowledgement. In a variant, the receiving the indication may include receiving the indication in a radio resource control reconfiguration complete message.

A fifth embodiment may be directed to an apparatus including at least one processor and at least one memory comprising computer program code. The at least one memory and computer program code may be configured, with the at least one processor, to cause the apparatus at least to perform the method according to the first embodiment, the second embodiment, the third embodiment, or the fourth embodiment, or any of the variants discussed above.

A sixth embodiment may be directed to an apparatus that may include circuitry configured to cause the apparatus to perform the method according to the first embodiment, the second embodiment, the third embodiment, or the fourth embodiment, or any of the variants discussed above.

A seventh embodiment may be directed to an apparatus that may include means for performing the method according to the first embodiment, the second embodiment, the third embodiment, or the fourth embodiment, or any of the variants discussed above. Examples of the means may include one or more processors, memory, and/or computer program codes for causing the performance of the operation.

An eighth embodiment may be directed to a computer readable medium comprising program instructions stored thereon for causing an apparatus to perform at least the method according to the first embodiment, the second embodiment, the third embodiment, or the fourth embodiment, or any of the variants discussed above.

A ninth embodiment may be directed to a computer program product encoding instructions for causing an apparatus to perform at least the method according to the first embodiment, the second embodiment, the third embodiment, or the fourth embodiment, or any of the variants discussed above.

### BRIEF DESCRIPTION OF THE DRAWINGS

For proper understanding of example embodiments, reference should be made to the accompanying drawings, wherein:

FIG. 1a illustrates a portion of an example signal diagram for reducing uplink interruption in DAPS handover, according to some embodiments;

FIG. 1b illustrates another portion of an example signal diagram for reducing uplink interruption in DAPS handover, according to some embodiments;

FIG. 2a illustrates a portion of an example signal diagram for reducing uplink interruption in DAPS handover, according to some embodiments;

FIG. 2b illustrates another portion of an example signal diagram for reducing uplink interruption in DAPS handover, according to some embodiments;

FIG. 3 illustrates an example flow diagram of a method, according to some embodiments;

FIG. 4 illustrates an example flow diagram of a method, according to some embodiments;

FIG. 5 illustrates an example flow diagram of a method, according to some embodiments;

FIG. 6 illustrates an example flow diagram of a method, according to some embodiments;

FIG. 7a illustrates an example block diagram of an apparatus, according to an embodiment; and

FIG. 7b illustrates an example block diagram of an apparatus, according to another embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for reducing uplink interruption in DAPS handover is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar wording, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar wording, throughout this specification do not necessarily all refer to the same group of embodiments, and the described features, structures, or characteristics may be combined in any suitable manner in one or more example embodiments. In addition, the phrase “set of” refers to a set that includes one or more of the referenced set members. As such, the phrases “set of,” “one or more of,” and “at least one of,” or equivalent phrases, may be used interchangeably. Further, “or” is intended to mean “and/or,” unless explicitly stated otherwise.

Additionally, if desired, the different functions or operations discussed below may be performed in a different order and/or concurrently with each other. Furthermore, if desired, one or more of the described functions or operations may be optional or may be combined. As such, the following description should be considered as merely illustrative of the principles and teachings of certain example embodiments, and not in limitation thereof.

Aspects of NR may relate to DAPS handover. One objective of DAPS is to reduce the service interruption that is otherwise experienced during a non-DAPS handover procedure, in particular for downlink (DL). In DAPS, each of the source and target cells may have a full layer 2 (L2) protocol stack with its own security key for ciphering and deciphering of the packet data convergence protocol (PDCP) service data units (SDUs). To avoid a hard handover causing service interruption, a UE served by a source cell may establish an additional radio link with respect to a target cell before detaching a radio link of the source cell. As a result, for some time before releasing the connection to the source cell, the UE may be able to exchange data with both source and target nodes.

Certain operations of DAPS are not similar to a non-DAPS handover. After receiving a handover command, the UE may continue exchanging user data with the source cell (controlled by a source node), even when sending a random access channel (RACH) preamble to the target cell (controlled by a target node). The received user data may be ciphered by the key of the source cell. When the UE completes the random access successfully to the target cell (e.g., receives a RACH response (RAR) in the case of contention free random access (CFRA), or physical downlink control channel (PDCCH) addressed to a cell radio network temporary identifier (C-RNTI) in case of contention based random access (CBRA)), the UE may switch the uplink (UL) user plane transmission from the source cell to the target cell. That is, after the UL switch, the UE may start to send new PDCP SDUs and the PDCP SDUs for which the successful delivery has not been confirmed by lower layers to the target cell. However, other UL transmissions towards the source cell (e.g. hybrid automatic repeat request (HARQ) and radio link control (RLC) (re)transmissions, HARQ feedback, RLC/PDCP status report, channel state information (CSI) measurements, etc.) may be continued.

After completing the access to the target cell, the UE may receive downlink (DL) user data with the source cell and target cell that are ciphered with different security keys. The UE may apply the security keys of the target cell for UL transmission on physical uplink shared channel (PUSCH). After the UE has established a new radio link with the target cell, the target cell may send, to the source cell, a handover success indication, and the source cell may provide a sequence number (SN) status transfer message to the target cell. Upon receiving the SN status transfer, the target cell can forward the buffered UL packets received from the UE to a user plane function (UPF). The target cell may send an explicit message for the UE to release the source link and path switch may be performed, which may complete the handover.

Certain aspects of NR may include delay parameters, such as for factory scenarios. In particular, there may be delay parameters in vertical domains. For a periodic deterministic communication, packets may arrive periodically where the transfer interval or inter-arrival period of the packets can vary from 0.5 milliseconds (ms) to 500 ms depending on the use case. The message size in bytes may be small, e.g., ranging from 40 bytes up to 1 kilobytes (KB).

During an ongoing DAPS mobility procedure, the UE can transmit data packets also to the target cell after the UL switch is performed by the UE. However, the target cell may not forward the buffered UL packets received from the UE to the UPF and/or serving gateway before it receives the SN status transfer message. This may be the case because the radio access network (RAN) (receiver PDCP entity in UL) should ensure in-order data delivery to the UPF. Therefore, the target cell can start transferring the UL packets to the UPF after receiving the SN status transfer message. This may be done to allow the source cell to forward the UL packets to the UPF that are successfully received from the UE, after the UL switch, from pending medium access control (MAC) and RLC (re)-transmissions. This may increase the UL data interruption time of a new PDCP SDU by at least the time from the UL switch till the SN status transfer message is received along with the associated processing delays. It may be network implementation to decide when the target cell sends the handover success message to the source cell. This message can be delayed as the UE can benefit from the increased reliability achieved by duplicating the DL packets from both the source and target cell radio links.

One problem may be that depending on the traffic type, the forwarding of the buffered UL packets from the target cell to the UPF and/or serving gateway may be delayed unnecessarily in the following scenarios: 1) if the UE does not have any pending UL MAC or RLC (re)-transmissions to the source cell upon UL switch, and 2) the pending (re)-transmissions to the source cell may end shortly after the UL switch. These two scenarios may be particularly relevant for industrial Internet of things (IIoT) services, where the UE may periodically send small packets to the network. Certain problems may occur when the UL switch is performed in a time instant where the UE does not have any pending UL MAC or RLC (re)transmissions to the source cell (e.g., scenario 1 above). In this case, the reception of some packets may have been acknowledged by the source cell. As the packets may be very small in size, the transmission time for these packets (including re-transmissions) may be expected to be very short in NR. Although there may be no pending (re)-transmissions to the source cell when the UL switch occurs, the target gNB might not forward the received UL packets to the UPF and/or the serving gateway before it receives the SN status transfer message from the source gNB. In this example, the forwarding of additional UL packets may be delayed unnecessarily.

Certain problems may occur when the UL switch is performed in a time instant where the UE still has pending UL MAC or RLC (re-)transmissions to the source cell (e.g., scenario 2 above). As the packets may be very small in size, the transmission time for these packets may be expected to end shortly after the UL switch. The pending MAC and RLC (re-)transmissions may continue to the source cell after the UL switch. Although certain problems described above may relate to periodic traffic with a small packet size, the problems may occur whenever the UE does not have any pending MAC and RLC (re)-transmissions to the source cell upon UL switch or the pending (re)-transmissions may end shortly after the UL switch.

Some embodiments described herein may provide for reducing uplink interruption in DAPS handover. For example, the UE may transmit an indication either to a source cell or to a target cell that there is no more pending UL MAC and RLC (re)-transmissions to be transmitted to the source cell, after the UL switch to target cell occurs during a DAPS handover. Based on the received indication, the network (e.g., the source cell or target cell) may perform one or more actions to enable forwarding of the UL packets received from the UE by the target cell to the UPF and/or serving gateway. This may be performed without waiting to send a handover success message to the source cell and to receive the SN status transfer message from the source cell. In this way, certain embodiments may reduce or eliminate the UL data interruption during DAPS handovers.

In certain embodiments, the UE may transmit an implicit or explicit indication, to a source cell, e.g., via a MAC control element (CE) or physical (PHY) channel (e.g., PUCCH), that there is no more pending UL MAC and RLC (re)-transmissions to the source cell after the UL switch to the target cell during an ongoing DAPS handover, for example, when there are no pending packets to the source cell. Upon receiving the indication from the UE, the source cell may indicate, to the target cell, the identifier of the next UL packet (e.g., a sequence number) to be forwarded to the UPF and/or serving gateway via, e.g., a new message (e.g., a SN status transfer UL) over the Xn and/or X2 interface. Based on the indication from the source cell, the target cell can send the already received UL packets to the UPF and/or serving gateway.

In certain embodiments, the UE may transmit an implicit or explicit indication to a target cell via, e.g., a MAC CE or PHY channel (e.g., PUCCH) or a radio resource control (RRC) message that there is no more pending UL data to the source cell, when there is no more pending UL MAC and RLC (re)-transmissions to the source cell, after the UL switch to the target cell occurs in a DAPS handover. In some embodiments, the UE can transmit, to the target cell, information related to the last UL packet successfully transmitted to the source cell. In some embodiments, such information can include an identifier (e.g., an RLC or PDCP sequence number) of the next UL packet that is to be forwarded to a UPF and/or serving gateway. Using this indication from the UE, the target cell can send the UL packets received from the UE to the UPF and/or serving gateway.

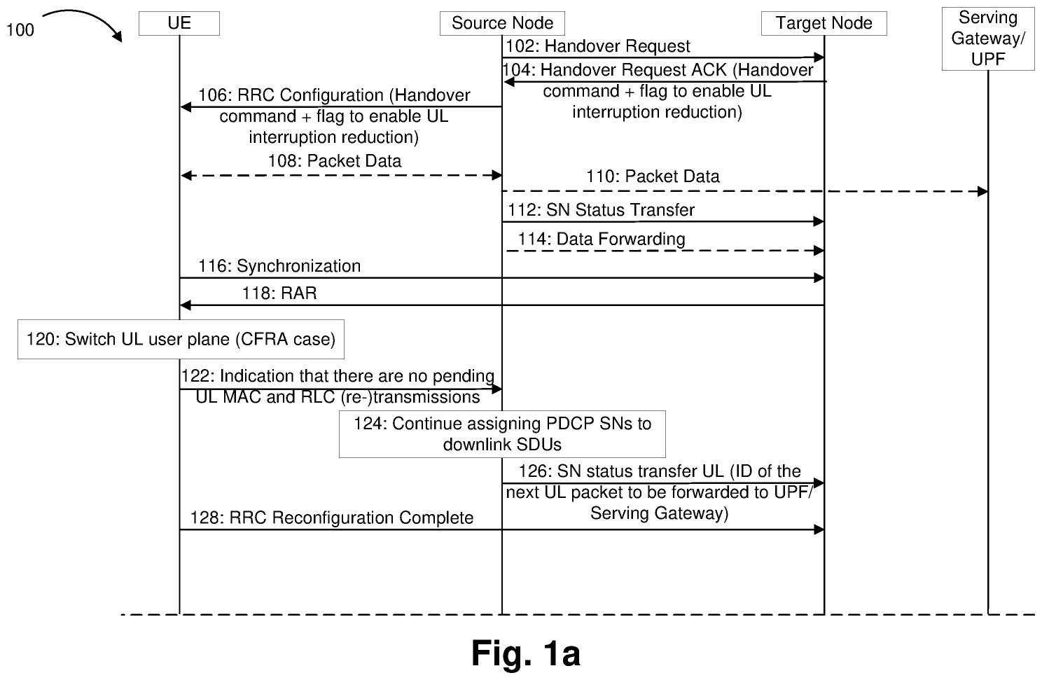

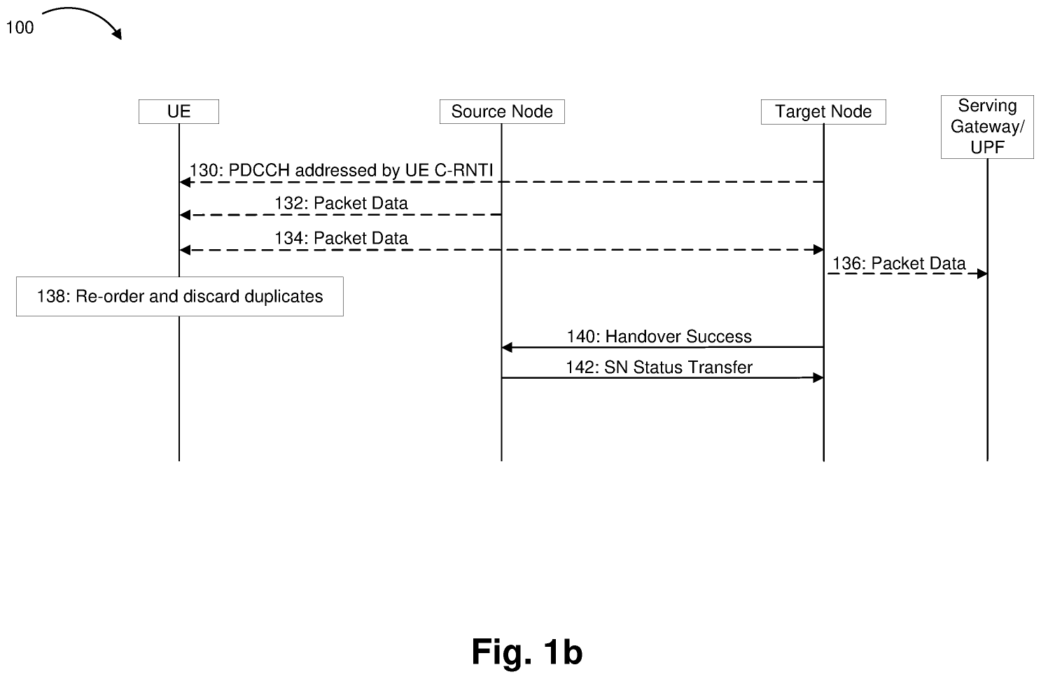

FIGS. 1a and 1b illustrate an example signal diagram 100 for reducing uplink interruption in DAPS handover, according to some embodiments. As illustrated in FIGS. 1a and 1b, the signal diagram 100 includes a UE, a source node, a target node, and a serving gateway and/or UPF (“serving gateway/UPF”).

FIG. 1a illustrates a portion of the example signal diagram 100. As illustrated at 102, the source node may transmit, and the target node may receive, a handover request. As illustrated at 104, the target node may transmit, and the source node may receive, a handover request acknowledgement (ACK). The ACK may include a handover command and a flag to enable UL interruption reduction. As illustrated at 106, the source node may transmit, and the UE may receive, an RRC configuration, e.g., that includes the handover command and the flag. As illustrated at 108, the UE and the source node may exchange packet data. As illustrated at 110, the source node may transmit, and the serving gateway and/or UPF may receive, packet data.

As illustrated at 112, the source node may transmit, and the target node may receive, an SN status transfer. As illustrated at 114, the source node may perform data forwarding to the target node. As illustrated at 116, the UE may transmit, and the target node may receive, synchronization signaling, e.g., RACH preamble. As illustrated at 118, the target node may transmit, and the UE may receive, a RAR. As illustrated at 120, the UE may switch the UL user plane (e.g., in the CFRA case). As illustrated at 122, the UE may transmit, and the source node may receive, an indication that there are no pending UL MAC and RLC (re-)transmissions. As illustrated at 124, the source node may continue assigning PDCP SNs to downlink SDUs.

As illustrated at 126, the source node may transmit, and the target node may receive, a SN status transfer for UL, e.g., that includes an identifier (ID) of the next UL packet to be forwarded to the serving gateway and/or UPF. As illustrated at 128, the UE and the target node may exchange RRC configuration complete messages.

Turning to FIG. 1b, FIG. 1b illustrates another portion of the example signal diagram 100. As illustrated at 130, the target node may transmit, and the UE may receive, a PDCCH transmission addressed by UE C-RNTI. As illustrated at 132, the source node may transmit, and the UE may receive, packet data. As illustrated at 134, the UE and the target node may exchange packet data. As illustrated at 136, the target node may transmit, and the serving gateway and/or UPF may receive, packet data. As illustrated at 138, the UE may re-order and discard duplicates. As illustrated at 140, the target node may transmit, and the source node may receive, a handover success and, as illustrated at 142, the source node may transmit, and the target node may receive, an SN status transfer.

In this way, the example signal diagram 100 illustrates certain embodiments related to a CFRA case, but certain embodiments may also apply to CBRA cases. As described above, the source cell may signal, to the UE, a flag enabling UL interruption reduction during DAPS. The flag can be boolean with, e.g., 0 and 1 values, an enumerated information element (IE) with true or false values, and/or the like. The flag may be set by the target cell and may be included in the handover command (e.g., as illustrated at 104 in FIG. 1a). Alternatively, the flag may be set by the source cell and may be sent in RRC configuration including the handover command, e.g., the flag may be sent in the same RRC message, but not included in the container with the handover command.

In certain embodiments, the UE may indicate, to the source cell after the UL switch, that there are no more pending MAC and RLC (re)-transmissions to the source cell. The indication can be sent either on PUCCH or MAC CE. In case of a central unit (CU)-distributed unit (DU) split architecture, the indication may be transmitted from the DU to the CU over an F1 interface. In certain embodiments, the source cell may send a new message to a target cell called the SN status transfer UL at 128 of FIG. 1a indicating the ID of the next UL packet to be forwarded to the UPF and/or serving gateway. Upon receiving this message, the target cell may forward the UL packets (PDCP SDUs) that are received from the UE.

The indication sent at 122 in FIG. 1a may be sent to the source cell before or after a RRC reconfiguration complete message is sent to the target cell. In certain embodiments, as an alternative to the operations at 122, the UE may inform the source node when the UL switch is performed or when the random access is successfully completed to the target node. Having received this indication from the UE, the source node may check if the UE still has some pending MAC or RLC (re)-transmissions to the source node. In some cases, the UE may not have any pending (re)-transmissions, and the source node may send the SN status transfer UL as shown at 126 of FIG. 1a.

As described above, FIGS. 1a and 1b are provided as examples. Other examples are possible, according to some embodiments.

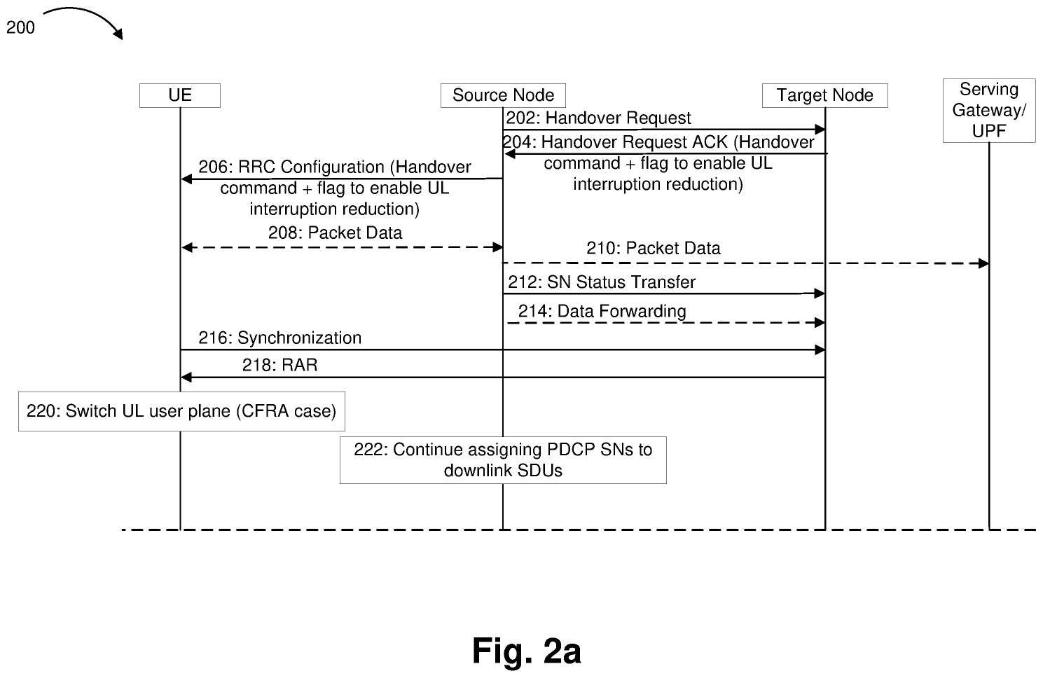

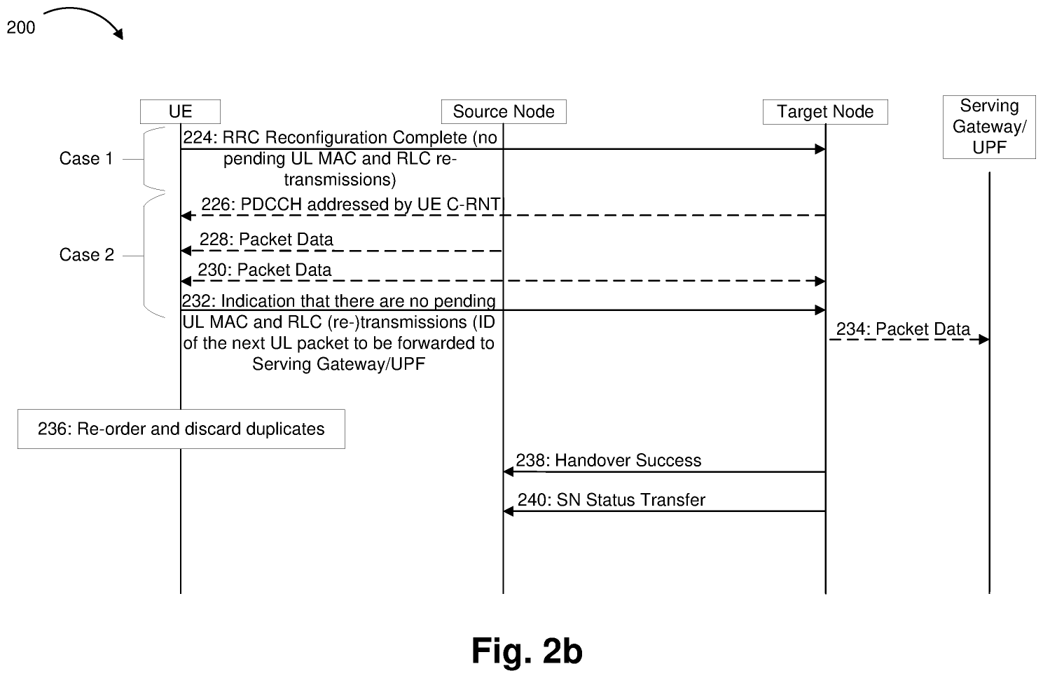

FIGS. 2a and 2b illustrate portions of an example signal diagram 200 for reducing uplink interruption in DAPS handover, according to some embodiments. As illustrated in FIGS. 2a and 2b, the example signal diagram 200 includes a UE, a source node, a target node, and a serving gateway and/or UPF.

The operations illustrated at 202, 204, 206, 208, 210, 212, 214, 216, 218, and 220 may be similar to the operations illustrated at 102, 104, 106, 108, 110, 112, 114, 116, 118, and 120 of FIG. 1a, respectively. As illustrated at 222, the source node may continue assigning PDCP SNs to downlink SDUs.

Turning to FIG. 2b, as illustrated at 224, the UE may transmit, and the target node may receive, a RRC reconfiguration complete message including an indication that there were no pending UL MAC and RLC re-transmissions. The operations at 224 may be associated with a first use case (case 1) of certain embodiments. The operations illustrated at 226, 228, 230, and 232 may be associated with a second use case (case 2). As illustrated at 226, the target node may transmit, and the UE may receive, a PDCCH addressed by UE C-RNTI. As illustrated at 228, the source node may transmit, and the UE may receive, packet data and, as illustrated at 230, the UE and the target node may exchange packet data. As illustrated at 232, the UE may transmit, and the target node may receive, an indication that there are no pending UL MAC and RLC (re-)transmissions, including the ID of the next UL packet to be forwarded to the serving gateway and/or UPF. The operations illustrated at 234, 236, 238, and 240 may be similar to the operations illustrated at 136, 138, 140, and 142 of FIG. 1b.

In this way, certain embodiments illustrated in, and described with respect to, FIGS. 2a and 2b may relate to a CFRA case, but certain embodiments may also apply to CBRA cases. In certain embodiments, the UE may indicate, to the target after the UL switch, that there are no more pending MAC and RLC (re)-transmissions to the source cell, as described for the case 1 or the case 2. In the case 1, upon UL switch, the UE may not have any pending MAC or RLC (re)-transmissions to the source cell. In this case, the indication may be sent either as MAC CE or in a RRC reconfiguration complete message. In the case 2, upon UL switch, the UE may have some pending MAC or RLC (re)-transmissions to the source cell which may be completed shortly after UL switch. In this case, the indication may be sent either using PUCCH, MAC CE, or RRC. The UE may also inform the target about the ID of the next UL packet to be forwarded to the serving gateway and/or UPF. In the case of a CU-DU split architecture, the indication may be transmitted from the DU to the CU over the F1 interface. In certain embodiments, the target cell may forward the UL packet to serving gateway and/or UPF once it receives the indication from the UE.

In certain embodiments, upon receiving the indication that there are no pending UL MAC and RLC retransmissions from the UE at 224 and 232 in FIG. 2b, the target gNB may request, from the source gNB, to send the SN status transfer UL (e.g., similar to that at 126 of FIG. 1a). Upon receiving the SN status transfer UL message from the source gNB, the target gNB may start to forward the buffered UL user plane packets to serving gateway and/or UPF. In this way, certain embodiments may apply in the case where the target cell gNB may determine to delay the transmission of handover success to the source gNB in order to improve the reliability of the DL user plane packets during DAPS handover.

As indicated above, FIGS. 2a and 2b are provided as examples. Other examples are possible, according to some embodiments.

In certain embodiments, the UE may send the indication to the source cell (e.g., at 122 of FIG. 1a) or the target cell (e.g., at 224 and 232 of FIG. 2b) if the MAC and RLC (re)-transmissions to the source cell are completed before a timer T with a pre-configured time duration X expires. The time duration X can be configured either by the source cell or target cell and may be sent to the UE in an RRC configuration message containing the handover command. If the target cell is planning to send a handover success message shortly after receiving the RRC reconfiguration complete message, then it may set the time duration X to a small value, e.g., 10 ms. Otherwise, the target cell can set the time duration X to a longer value, e.g., 100 ms, if it is planning to keep the source cell for a longer time (for improving the reliability in DL by means of packet duplication from source and target cell). The timer T may be started by the UE when the UL switch to the target cell occurs. The timer T may be stopped if the MAC and RLC (re)-transmissions to the source cell are completed. According to some embodiments, the indication may be sent by the UE to the source cell or target cell. The timer T may expire if the MAC and RLC (re)-transmissions to the source cell are not completed. According to certain embodiments, the indication may not be sent by the UE to the source cell or the target cell. The network may then determine that there are UL transmissions still pending, and forwarding of buffered packets to the UPF may not yet be possible.

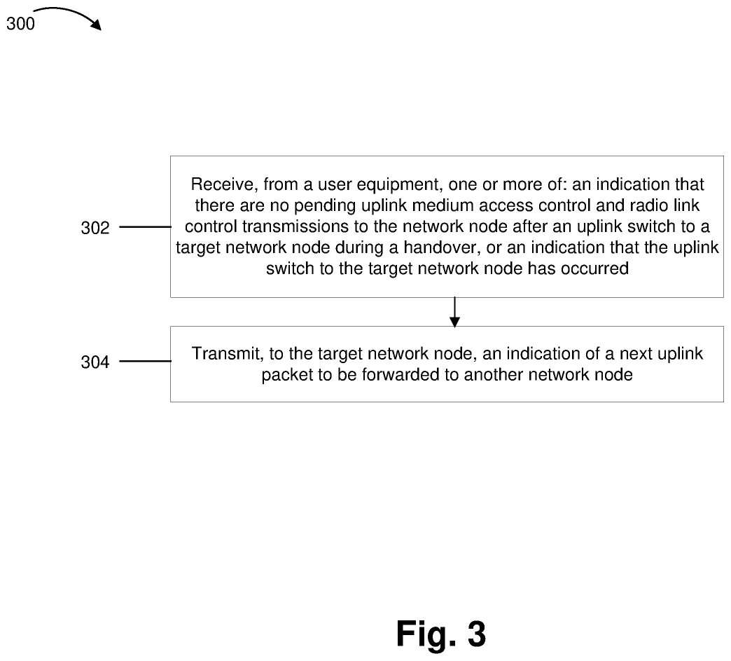

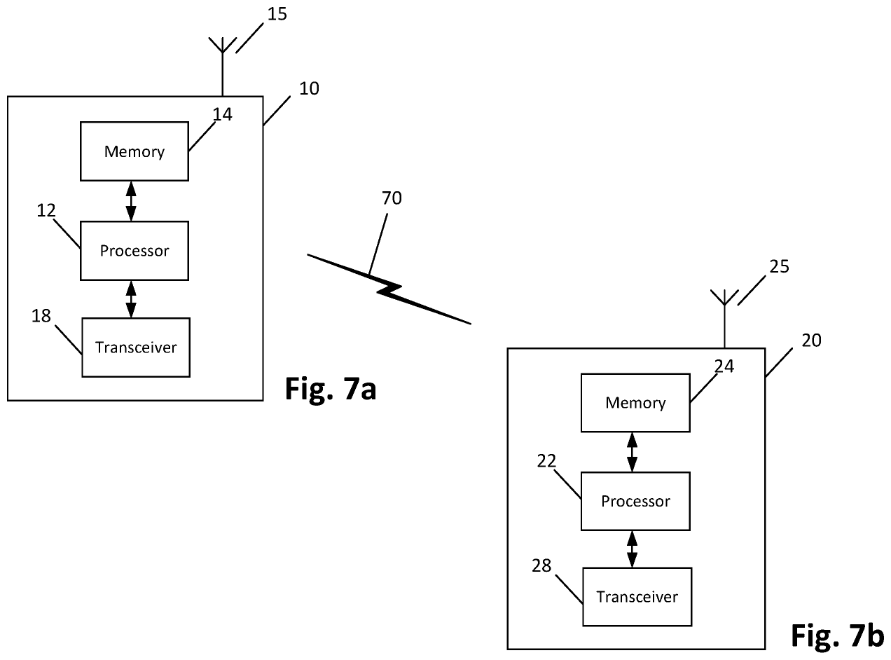

FIG. 3 illustrates an example flow diagram of a method 300, according to some embodiments. For example, FIG. 3 may illustrate example operations of a network node (e.g., a source node) (e.g., apparatus 10 illustrated in, and described with respect to, FIG. 7a). Some of the operations illustrated in FIG. 3 may be similar to some operations shown in, and described with respect to, FIGS. 1a and 1b.

In an embodiment, the method 300 may include, at 302, receiving, from a user equipment, one or more of: an indication that there are no pending uplink medium access control and radio link control transmissions to the network node after an uplink switch to a target network node during a handover, or an indication that the uplink switch to the target network node has occurred. For example, the receiving at 302 may be performed in a manner similar to that at 122 of FIG. 1a. The method 300 may include, at 304, transmitting, to the target network node, an indication of a next uplink packet to be forwarded to another network node, e.g., in a manner similar to that at 126 of FIG. 1a.

The method illustrated in FIG. 3 may include one or more additional aspects described below or elsewhere herein. In some embodiments, the method 300 may further include transmitting, to the user equipment prior to receiving the indication that there are no pending uplink medium access control and radio link control transmissions to the source network node after an uplink switch or the indication that the uplink switch to the target node has occurred, an indication to enable uplink interruption reduction during the handover, e.g., in a manner similar to that at 106 of FIG. 1a. In some embodiments, the indication to enable the uplink interruption reduction may be transmitted in a radio resource control configuration message. In some embodiments, the handover may include a dual active protocol stack handover. In some embodiments, the indication transmitted at 304 may be transmitted in a SN status transfer uplink message. In some embodiments, the other network node may include at least one of a serving gateway or a user plane node, e.g., user plane function (UPF). In some embodiments, the method 300 may further include determining whether the user equipment has the pending uplink medium access control and radio link control transmissions based on receiving the indication that the uplink switch to the target network node has occurred.

As described above, FIG. 3 is provided as an example. Other examples are possible according to some embodiments.

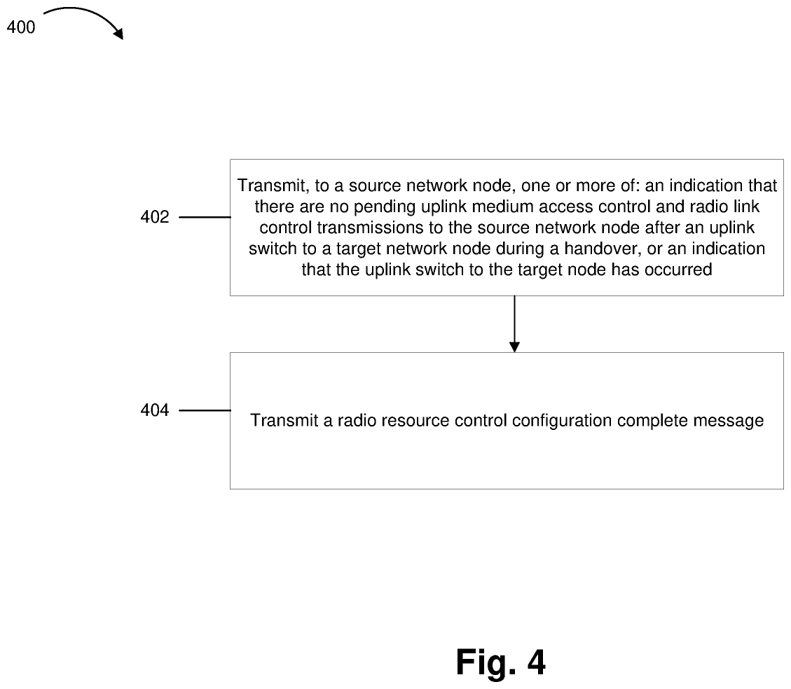

FIG. 4 illustrates an example flow diagram of a method 400, according to some embodiments. For example, FIG. 4 may illustrate example operations of a UE (e.g., apparatus 20 illustrated in, and described with respect to, FIG. 7b). Some of the operations illustrated in FIG. 4 may be similar to some operations shown in, and described with respect to, FIGS. 1a and 1b.

In an embodiment, the method 400 may include, at 402, transmitting, to a source network node, one or more of: an indication that there are no pending uplink medium access control and radio link control transmissions to the source network node after an uplink switch to a target network node during a handover, or an indication that the uplink switch to the target node has occurred. For example, the transmitting at 402 may be performed in a manner similar to that at 122 of FIG. 1a. The method 400 may include, at 404, transmitting a radio resource control configuration complete message, e.g., in a manner similar to that at 128 of FIG. 1a.

The method 400 illustrated in FIG. 4 may include one or more additional aspects described below or elsewhere herein. In some embodiments, the method 400 may include receiving, from the source network node prior to transmitting the indication that there are no pending uplink medium access control and radio link control transmissions to the source network node after an uplink switch or the indication that the uplink switch to the target node has occurred, an indication to enable uplink interruption reduction during the handover, e.g., in a manner similar to that at 106 of FIG. 1a. The indication to enable uplink interruption reduction during the handover could be in the form of a request from the network to transmit the indication that there are no pending transmissions or the indication that uplink switch has occurred. In some embodiments, the indication to enable the uplink interruption reduction may be received in a radio resource control configuration message. In some embodiments, the handover may include a dual active protocol stack handover.

As described above, FIG. 4 is provided as an example. Other examples are possible according to some embodiments.

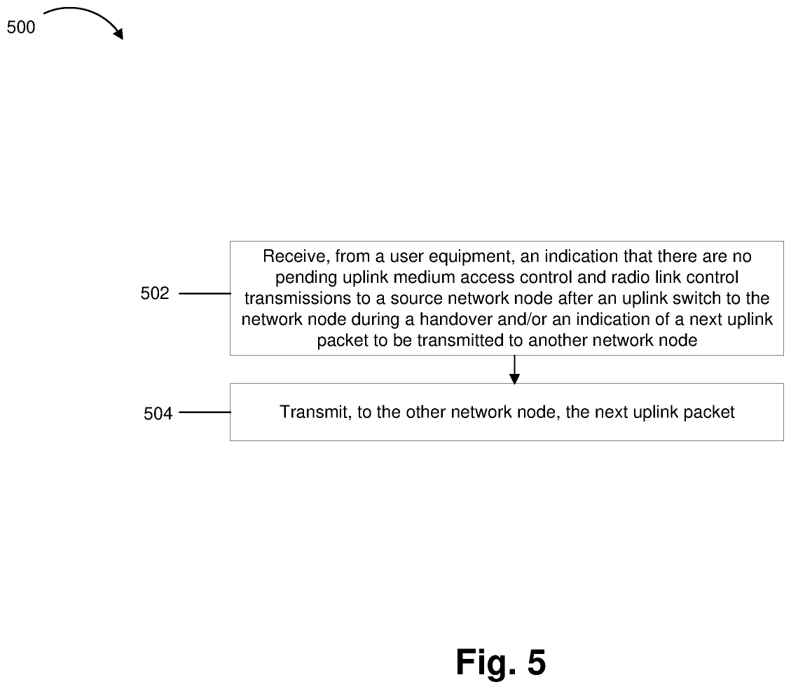

FIG. 5 illustrates an example flow diagram of a method 500, according to some embodiments. For example, FIG. 5 may illustrate example operations of a network node (e.g., a target node) (e.g., apparatus 10 illustrated in, and described with respect to, FIG. 7a). Some of the operations illustrated in FIG. 5 may be similar to some operations shown in, and described with respect to, FIGS. 2a and 2b.

In an embodiment, the method 500 may include, at 502, receiving, from a user equipment, an indication that there are no pending uplink medium access control and radio link control transmissions to a source network node after an uplink switch to the network node during a handover and/or an indication of a next uplink packet to be transmitted to another network node. For example, the receiving at 502 may be performed in a manner similar to that at 224 or 232 of FIG. 2b. The method 500 may include, at 504, transmitting, to the other network node, the next uplink packet, e.g., in a manner similar to that at 234 of FIG. 2b.

The method 500 illustrated in FIG. 5 may include one or more additional aspects described below or elsewhere herein. In some embodiments, the method 500 may include transmitting, to the source network node, an indication to enable uplink interruption reduction during the handover, e.g., in a manner similar to that at 204 of FIG. 2b. The indication to enable uplink interruption reduction during the handover could be in the form of a request from the network to transmit the indication that there are no pending transmissions or the indication that uplink switch has occurred. In some embodiments, the indication to enable the uplink interruption reduction may be transmitted in a handover request acknowledgement. In some embodiments, the indication received at 502 may be received in a radio resource control configuration complete message.

As described above, FIG. 5 is provided as an example. Other examples are possible according to some embodiments.

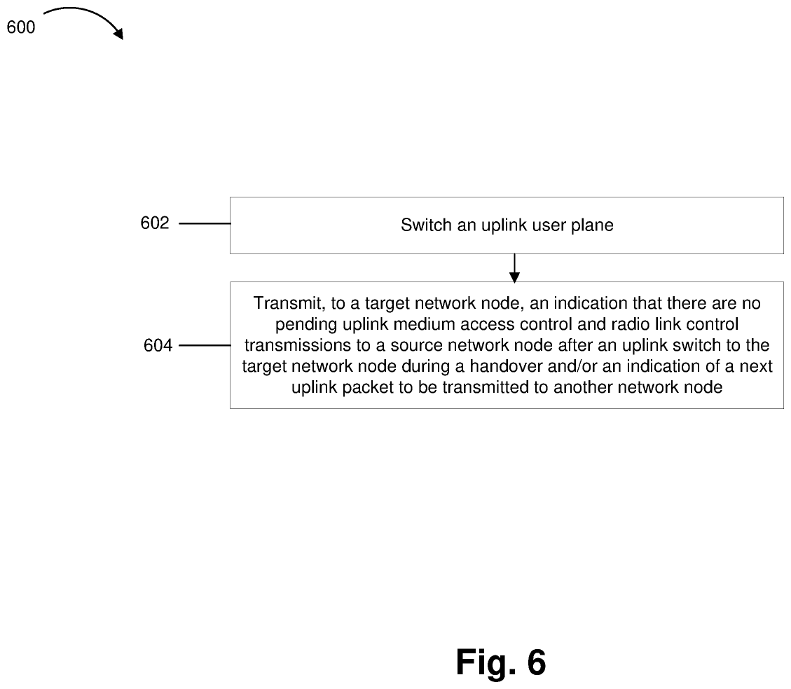

FIG. 6 illustrates an example flow diagram of a method 600, according to some embodiments. For example, FIG. 6 may illustrate example operations of a UE (e.g., apparatus 20 illustrated in, and described with respect to, FIG. 7b). Some of the operations illustrated in FIG. 6 may be similar to some operations shown in, and described with respect to, FIGS. 2a and 2b.

In an embodiment, the method 600 may include, at 602, switching an uplink user plane, e.g., in a manner similar to that at 220 of FIG. 2a. The method 600 may include, at 604, transmitting, to a target network node, an indication that there are no pending uplink medium access control and radio link control transmissions to a source network node after an uplink switch to the target network node during a handover and/or an indication of a next uplink packet to be transmitted to another network node. The transmitting at 604 may be performed in a manner similar to that at 224 or 232 of FIG. 2b.

The method 600 illustrated in FIG. 6 may include one or more additional aspects described below or elsewhere herein. In some embodiments, the method 600 may include receiving, from the source network node, an indication to enable uplink interruption reduction during the handover, e.g., in a manner similar to that at 206 of FIG. 2a. In some embodiments, the indication to enable the uplink interruption reduction may be received in a radio resource control configuration message. In some embodiments, the indication transmitted at 604 may be transmitted in a radio resource control reconfiguration complete message. In some embodiments, the indication transmitted at 604 may be transmitted after switching the uplink user plane.

As described above, FIG. 6 is provided as an example. Other examples are possible according to some embodiments.

FIG. 7a illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), and/or a WLAN access point, associated with a radio access network, such as a LTE network, 5G or NR. In some example embodiments, apparatus 10 may be an eNB in LTE or gNB in 5G.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 7a.

As illustrated in the example of FIG. 7a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 7a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, or the like.

According to certain embodiments, apparatus 10 may be controlled by memory 14 and processor 12 to perform the functions associated with any of the embodiments described herein, such as some operations illustrated in, or described with respect to, FIGS. 1a-3 and 5. For instance, apparatus 10 may be controlled by memory 14 and processor 12 to perform the methods of FIGS. 3 and 5.

FIG. 7b illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 7b.

As illustrated in the example of FIG. 7b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry. As discussed above, according to some embodiments, apparatus 20 may be a UE, mobile device, mobile station, ME, IoT device and/or NB-IoT device, for example. According to certain embodiments, apparatus 20 may be controlled by memory 24 and processor 22 to perform the functions associated with any of the embodiments described herein, such as some operations illustrated in, or described with respect to, FIGS. 1a-2b, 4, and 6. For instance, in one embodiment, apparatus 20 may be controlled by memory 24 and processor 22 to perform the methods of FIGS. 4 and 6.

In some embodiments, an apparatus (e.g., apparatus 10 and/or apparatus 20) may include means for performing a method or any of the variants discussed herein, e.g., a method described with reference to FIGS. 3-6. Examples of the means may include one or more processors, memory, and/or computer program code for causing the performance of the operation.

Therefore, certain example embodiments provide several technological improvements, enhancements, and/or advantages over existing technological processes. For example, one benefit of some example embodiments is a reduction in the UL interruption time in DAPS in the case there are no pending MAC and RLC (re-)transmissions to the source cell upon, or shortly after, the UL switch. Another benefit of some embodiments is that the source link can be kept by the target cell for a longer time for improved reliability without delaying the transmission of the buffered UL packets to the serving gateway and/or UPF. Accordingly, the use of some example embodiments results in improved functioning of communications networks and their nodes and, therefore constitute an improvement at least to the technological field of DAPS handover, among others.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and may include program instructions to perform particular tasks.

A computer program product may include one or more computer-executable components which, when the program is run, are configured to carry out some example embodiments. The one or more computer-executable components may be at least one software code or portions of code. Modifications and configurations used for implementing functionality of an example embodiment may be performed as routine(s), which may be implemented as added or updated software routine(s). In one example, software routine(s) may be downloaded into the apparatus.

As an example, software or a computer program code or portions of code may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, such as a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein apply equally to both singular and plural implementations, regardless of whether singular or plural wording is used in connection with describing certain embodiments. For example, an embodiment that describes operations of a single network node equally applies to embodiments that include multiple instances of the network node, and vice versa.

One having ordinary skill in the art will readily understand that the example embodiments as discussed above may be practiced with operations in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

CBRA Contention Based Random Access
CE Control Element
CFRA Contention Free Random Access
C-RNTI Cell Radio Network Temporary Identifier
DAPS Dual Active Protocol Stack
DL Downlink
HARQ Hybrid Automatic Repeat Request
ID Identity
LTE Long Term Evolution
MAC Medium Access Control
NR New Radio
PDCCH Physical Downlink Control Channel
PDCP Packet Data Convergence Protocol
PDU Packet Data Unit
PUCCH Physical Uplink Control Channel
PUSCH Physical Uplink Shared Channel
RACH Random Access Channel
RLC Radio Link Control
SDU Service Data Unit
SN Sequence Number
UL Uplink
UPF User Plane Function

1-32. (canceled)

33. An apparatus, comprising:
at least one processor; and
at least one memory including computer program code,
wherein the at least one memory and the computer program code are configured to, with the at least one processor, cause the apparatus at least to:
transmit, to a source or target network node:
an indication that there are no pending uplink medium access control and radio link control transmissions to the source network node after an uplink switch to the target network node during a handover, and.
receive, from the source network node prior to transmitting the indication that there are no pending transmissions, an indication to enable uplink interruption reduction during the handover.

34. The apparatus according to claim 33, wherein the at least one memory and the computer program code are configured to, with the at least one processor, further cause the apparatus, when receiving the indication to enable the uplink interruption reduction, at least to:
receive the indication to enable the uplink interruption reduction in a radio resource control configuration message.

35. The apparatus according of claim 33, wherein the handover comprises a dual active protocol stack handover.

36. An apparatus, comprising:
at least one processor; and
at least one memory including computer program code,
wherein the at least one memory and the computer program code are configured to, with the at least one processor, cause the apparatus at least to:
receive, from a user equipment, one or more of:
an indication that there are no pending uplink medium access control and radio link control transmissions to the apparatus after an uplink switch to a target network node during a handover, transmit, to the target network node, an indication of a next uplink packet to be forwarded to another network node; and.
transmit, to the user equipment prior to receiving the indication that there are no pending transmissions, an indication to enable uplink interruption reduction during the handover.

37. The apparatus according to claim 36, wherein the at least one memory and the computer program code are configured to, with the at least one processor, further cause the apparatus, when transmitting the indication to enable the uplink interruption reduction, at least to:
transmit the indication to enable the uplink interruption reduction in a radio resource control configuration message.

38. The apparatus according to any of claim 36, wherein the handover comprises a dual active protocol stack handover.

39. The apparatus according to claim 36, wherein the at least one memory and the computer program code are configured to, with the at least one processor, further cause the apparatus, when transmitting the indication of the next uplink packet, at least to:
transmit the indication of the next uplink packet in a sequence number status transfer uplink message.

40. The apparatus according to claim 36, wherein the other network node comprises at least one of a serving gateway or a user plane node.

41. The apparatus according to claim 33, wherein the at least one memory and the computer program code are configured to, with the at least one processor, further cause the apparatus, when transmitting the indication, at least to:
transmit the indication in a radio resource control reconfiguration complete message.

42. The apparatus according to claim 33, wherein the at least one memory and the computer program code are configured to, with the at least one processor, further cause the apparatus, when transmitting the indication, at least to:
transmit the indication after switching an uplink user plane.

43. A method, comprising:
transmitting, to a source or a target network node:
an indication that there are no pending uplink medium access control and radio link control transmissions to the source network node after an uplink switch to the target network node during a handover, and after receiving from the source node an indication to enable uplink interruption reduction during the handover.

44. A method, comprising:
receiving, from a user equipment:
an indication that there are no pending uplink medium access control and radio link control transmissions to the apparatus after an uplink switch to a target network node during a handover; and
transmitting, to the target network node, an indication of a next uplink packet to be forwarded to another network node.

45. A non-transitory computer-readable medium comprising program instructions stored thereon for causing an apparatus to perform the method of claim 43.

46. A non-transitory computer-readable medium comprising program instructions stored thereon for causing an apparatus to perform the method of claim 44.
